(19) United States
(12) Patent Application Publication
(10) Pub. No.: US 2016/0229076 A1
(43) Pub. Date: Aug. 11, 2016

(54) CUTTER FOR STRIP-SHAPED MATERIALS OF ALL KINDS

(71) Applicant: HENGSTLER GMBH, Aldingen (DE)

(72) Inventor: Erwin LINK, Trossingen (DE)

(21) Appl. No.: 14/898,223

(22) PCT Filed: May 6, 2014
(86) PCT No.: PCT/EP2014/001204

§ 371 Date: Mar. 29, 2016

(30) Foreign Application Priority Data
Jun. 13, 2013 (DE) 10 2013 009 872.6

(51) Int. Cl. B26D 3/12; B26D 5/08; B26D 1/45; B26D 1/02; B26D 1/08

(52) U.S. Cl. CPC B26D 3/12; B26D 1/025; B26D 1/085; B26D 1/455; B26D 5/086

(57) ABSTRACT

The invention relates to a cutter for strip or band-shaped materials of all kinds, having an electromotive drive for at least one blade (4, 5), which drives the at least one blade (4, 5) in a displaceable manner against a stationary knife (6), wherein the electromotive drive (motor 3) has parallel effect on the movement drive of at least two separately movable blades (4, 5), each of which are directed against the stationary knife (6), so that a material web (35) is cut having a longer first cut (36) and an opposite second cut (37) offset skewed to the first cut (36) and an uncut bridge (38) remains in the material web (35) between the two cuts.

The invention pertains to a cutter for strip-shaped materials of all kinds in accordance with the summary term of claim 1.

Prior art teaches a method for cutting strip-shaped materials with the help of a cutter. Such a cutter preferably comprises either a guillotine knife or a swivel knife.

In recent years, an increasing number of devices have come into use that execute the cutting process, but spare out a narrow bridge from the cutting process. The remaining bridge continues to form a small connection between the two sides to be separated. This is referred to as a partial cut, since the strip-shaped material is not completely cut through.

The essential advantage of a partial cut is that the part to be separated remains connected to the continuous material, which means, for example, that it cannot fall out of a dispenser device. Such a partial cut was previously made with devices having a blade arranged in a V-shape. The acute apex of the V-shape features a notch, which forms the required bridge. In such devices, the partial cut is always executed simultaneously by the two blades, which means that the cut is made both from the left side and the right side, sparing an uncut bridge in the center of the material from the cutting process. The industry is increasingly using individual packages made in sequence from continuous material. The individual packaging may contain products such as medications, tablets, chewing gum or the like. It is desirable for only one package and its contents to be available at a time. This requires cutters, which separate the continuous material with a partial cut up to a bridge.

In a preferred embodiment, the individual section or the individual packaging features a lateral cut, which is hereinafter referred to as an incision. Such an incision serves to easily tear open the individual package.

Such lateral incisions can for found, for example, in packaging for gummy bears or toys, wherein, starting from a continuous lateral edge, a minor cut is made in a small area, thereby allowing the user to easily tear open the entire package.

Prior art teaches a method to separate continuous material into certain subsections. Incisions made in the subsection are also known. However, the two steps have to be executed successively or with two different devices. Furthermore, the devices according to prior art have the disadvantage that the height of the continuous material is limited by the V-shaped arrangement of the knife. Packaging with larger package contents cannot be cut because the V-shaped blade arrangement does not permit it.

The purpose of the invention is to provide a device, which is able to execute both the partial cut and the incision, wherein materials with larger package contents can also be cut. The clearance height is to be larger than in conventional devices.

To solve this problem, the invention is characterized by the technical teaching of claim 1.

The essential characteristic of the invention is that the device only has a single electromotive drive, which drives two different blades.

In a preferred embodiment, the electromotive drive consists of an electric motor having a pinion gear on its drive shaft that engages with a sprocket and drives its rotation. However, the invention is not limited to the use of an electric motor. A driving pawl or driving anchor driven by an electromagnet can be used instead. For reasons of simplicity, the description below presumes the use of an electric motor, although the invention is not limited to it.

This results in the advantage that only one motor is required to execute the partial cut as well as the incision in a continuous material. In a first advantageous embodiment, the motor is designed as a DC motor, but other motor types are of course feasible as well.

The motor is connected to a sprocket, which comprises a catch. This catch is designed such that it engages with at least one contour of a blade and thus converts a rotary movement into a linear movement.

It is essential that the contours serve as sliding gates for the catch. The following description therefore presumes the contour to be a sliding gate or a sliding control. Such sliding gates are used in particular for the implementation of complex transmission functions.

The gate preferably comprises a slot, bridge or groove, which forces the path of the catch on both sides. The transmission function of the sliding gate is exclusively determined by the course of the slot, bridge or groove and is freely selectable within broad limits.

For example, the contour form can be a horizontal slot. Of course, the contour can also have any other shape, such as for example a slot inclined at an angle of 30° to the horizontal center axis.

Furthermore, the contour can be designed in such a way that the catch cannot execute a transmission function to the blade. In this case, the catch is swiveled by a rotary movement of the gear, e.g. by 180° downwards, but is not coming into contact with the blade contour. The blade contour comprises a larger, open recess, which is hereinafter referred to as a one-way clutch.

In a first embodiment, the first blade features an almost horizontal, slot-like contour. The power transmission from the catch to the contour of the first blade is direct. The first blade in its resting position is at its furthest distance from the opposite knife. The rotary movement of the motor in a first direction, for example to the left, turns the catch and moves the first blade downwards. The cutting process is effected by means of a close shearing of the blade past the opposite knife. Due to the width of the blade and the arrangement to the material to be cut, this embodiment only results in a lateral incision in the material. This means that the material only shows a small incision in the lateral edge area.

The second blade is designed, for example, as a swivel blade, which is unilaterally situated at a pivot. The contour of the second blade is designed to ensure that in the above-referenced rotary movement of the motor to the left, the catch moves within a one-way clutch, or a clutch surface. Accordingly, there is no power transmission from the catch to the second blade.

Once the first blade has reached the end position, the motor carries out a rotary movement in the opposite direction (e.g. to the right), which moves the blade back to the zero position or the rest position via the catch.

Another rotary movement in the opposite direction (e.g. to the right) causes the catch to engage with the contour of a second blade along with the contour of the first blade.

If the motor continues to move in a direction, for example to the right, the contour and the given gate move the second blade downwards. The second blade swivels down and slides past the horizontal knife. In a preferred embodiment, the horizontal knife serves as the counter-knife to the first and second blade.

The second blade is swiveled in the direction of the horizontal knife until it reaches an end position. The end position means that the corresponding blade has moved past the counter-knife and that the cutting process has been executed in all cases.

The second blade is designed or arranged in such a way to the counter-knife that no cutting process takes place in a small partial segment. This partial segment is hereinafter referred to as cut-free zone.

Accordingly, the continuous material is largely cut by the second blade, but no cutting process takes place in a small partial segment. It follows that only one partial cut is made. In the area of the cut-less zone, there is still a connection between the partial section to be cut off and the remainder of the continuous material.

The cut-free zone is large enough that the remaining bridge can easily be separated from the rest of the continuous material. This allows for separating a partial section from the continuous material at a later point.

The different design of the two blades for the first time makes it feasible to move a first blade in a vertical direction downwards, while a second blade is being swiveled. Thus, the first blade executes a lateral incision in the continuous material, while the second blade makes a partial cut in the same partial section of the continuous material. In another advantageous embodiment, the first blade also features a cam control with a one-way clutch. If the second blade is moved downwards with a certain rotary direction, the first blade remains in its rest position for lack of power transmission because of the one-way clutch area. When the motor reverses its direction of rotation, the sliding controls allow for moving the first blade downwards, while the second blade is swiveled. This makes it possible, for the first time, to use a single motor to drive two blades which can be controlled independently of one another.

The first blade can be designed, for example, as a guillotine blade and be made from steel, such as e.g. hardened steel. The device shall not be limited to this design and all known types of blades can be used in the cutting process.

The second blade can be designed, for example, as a swivel blade, wherein the blade swivels downwards, starting from a pivot point, to execute a cut against a counter-knife.

In one advantageous embodiment, the two above-mentioned blades cut against a horizontal knife. This makes it possible, for the first time, to carry out several cuts, such as incisions or partial cuts, in a partial section of a continuous material simultaneously.

The continuous material may be a continuous tube, but may also consist of a label, a foil material, or a paper material. Other items to be separated may include tickets, lining paper, laminated materials or various plastic materials.

It is essential for the device that the two blades can be moved into a relatively far (rest) position from the (counter-)knife based on the arrangement of the two blades and the use of cam controls. This creates a large clearance height for the continuous material to be separated.

For example, if the continuous material consists of a tubular foil, which is sealed on one side, wherein the tube features individual chambers, in which items such as tablets are arranged, it forms a certain material height. This material height should be less than the clearance height of the cutting device.

This feature was not known from prior art, since the known devices only specified a small opening, wherein only relatively flat, strip-shaped products could be cut.

In a first essential embodiment, a tube-shaped medium having a strip of 5 mm in a right-hand area is used. This strip is formed by a sealing process of the tube-shaped material and is particularly rigid (non-elastic) compared to the remaining material due to this sealing process. The device now allows for making an incision of a defined width in this areas, since the incision is made by a differently design blade than the blade that makes the partial cut.

The following section explains the invention in greater detail, using drawings that represent only one embodiment. The drawings and their description disclose further features and advantages of the invention.

The subject of the present invention not only results from the subject of the individual patent claims, but also from the combination of the individual patent claims.

The illustrations show the following:

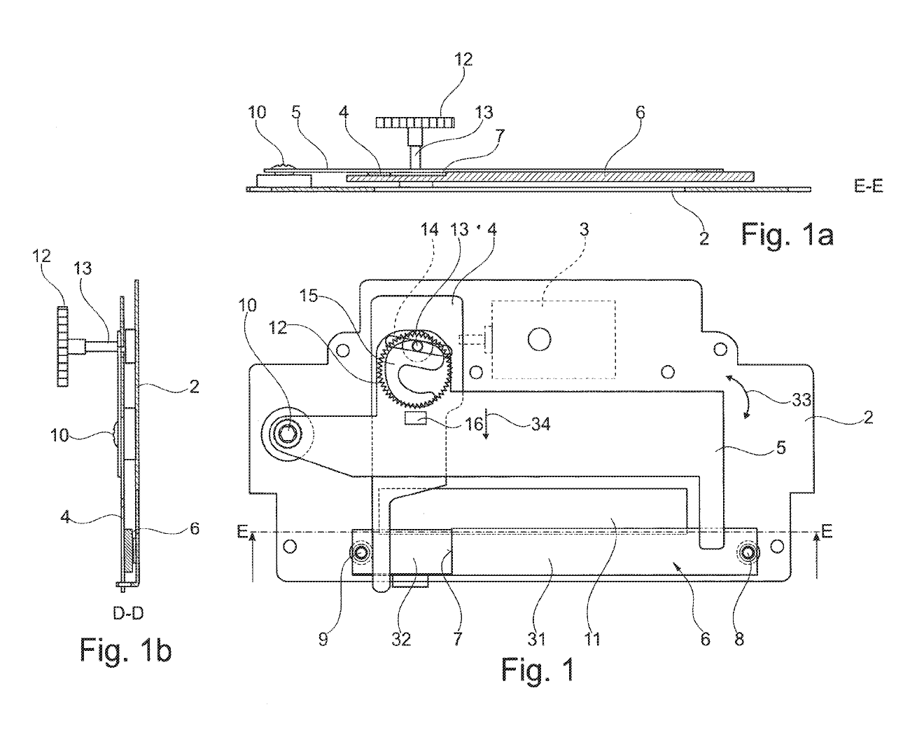

FIG. 1: shows the cutter in a rest position

FIG. 1a: Cut along the line E-E in FIG. 1

FIG. 1b: Cut along the line D-D in FIG. 1

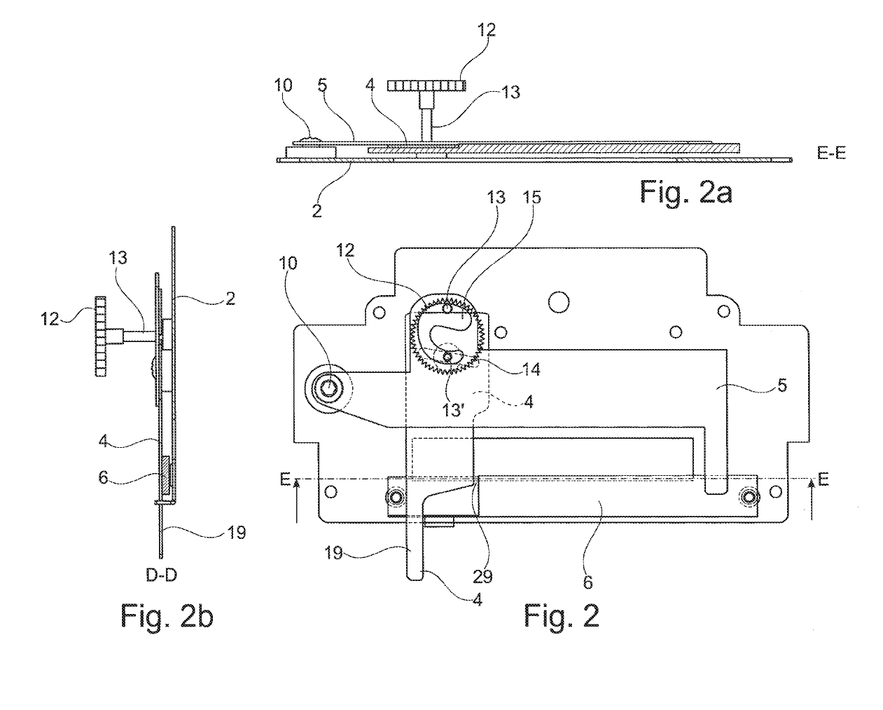

FIG. 2: shows the cutter, wherein blade 4 is moved downward in working position

FIG. 2a: Cut along the line E-E in FIG. 2

FIG. 2b: Cut along the line D-D in FIG. 2

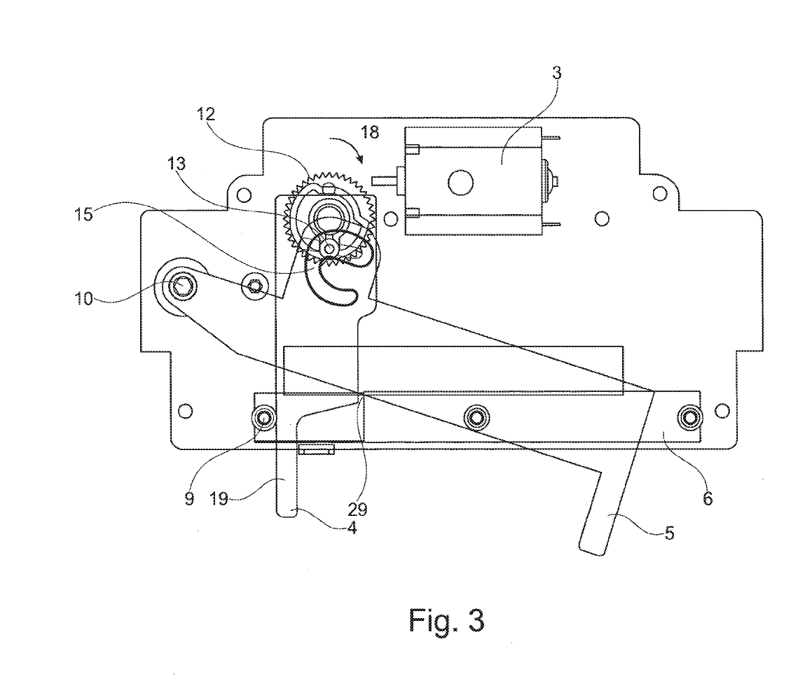

FIG. 3: shows the cutter with both blades 4 and 5 in working position

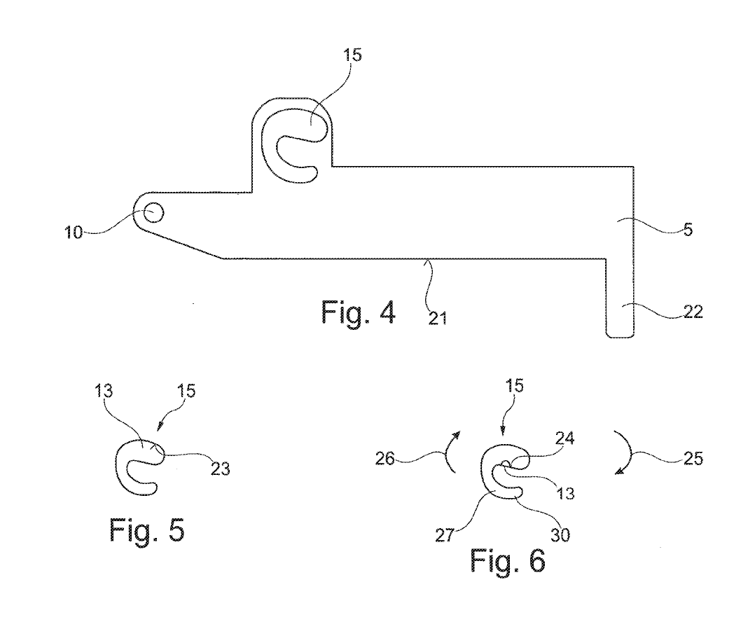

FIG. 4: Shows blade 5 in top view

FIG. 5: Shows the cam control of blade 5 in rest position

FIG. 6: Shows the cam control of blade 5 in working position

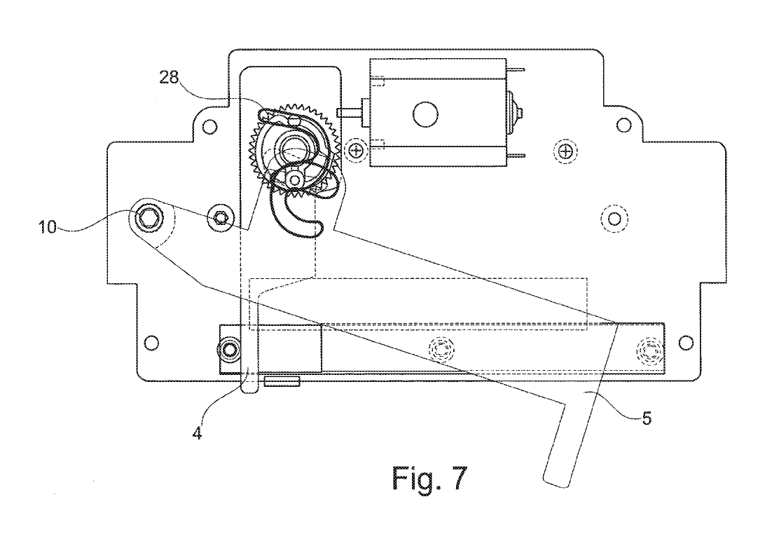

FIG. 7: Shows blade 5 in working position

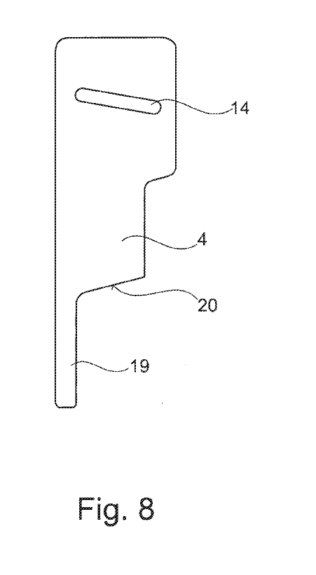

FIG. 8: Shows blade 4 in top view with a first contour

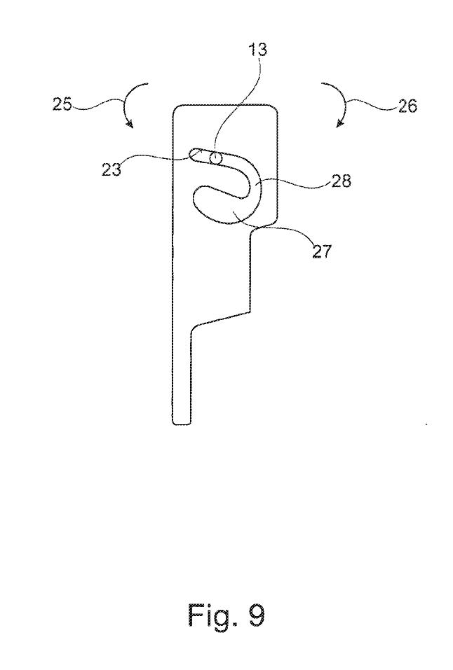

FIG. 9: Shows a special cam control or a second contour of blade 4

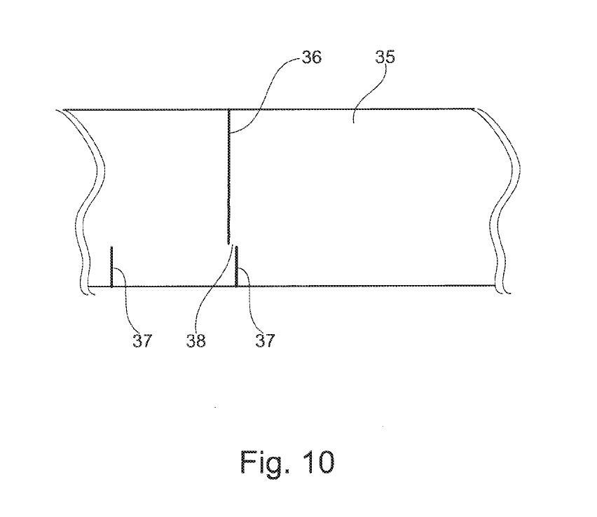

FIG. 10: Shows a cut through a paper sheet

FIG. 1 shows cutter 1 with both blades 4 and 5 in rest position.

FIGS. 1a and 1b show the same parts of FIG. 1 in a cross-section along lines D-D and E-E.

Cutter 1 features a base plate 2, on which a motor 3, a first blade 4 and a second blade 5 are arranged. Both blades 4, 5 are directed against a knife 6, which is set up in a stationary position horizontally on base plate 2 in the lower area. Knife 6 comprises two different areas, wherein blade 5 is pivoted against a first area, while blade 4 is vertically moved against the second area. Accordingly, blade 5 is designed as a swivel blade, while blade 4 is designed as a vertically moveable guillotine blade.

A step 7 is formed between the first and second area at knife 6, which ensures that blade 4 cannot lift blade 5 from knife 6.

Thus, the first blade 5 cuts against a first cutting range 31 of knife 6, while the second blade 4 cuts against a second cutting range 32 of knife 6.

As specified above, motor 3 can not only be situated on base plate 2, but also in a housing on the opposite side, and can be connected with the base plate and the blades 4, 5 arranged thereon via a mechanical drive.

Thus, the drive can be situated in a housing and the connection to the two blades 4, 5 is made by a catch.

Knife 6 is connected to base plate 2 via a first mounting point 8 as well as a second mounting point 9. In an advantageous embodiment, the second mounting point 9 can be designed in such a way that it serves as a guiding point for the first blade 4 during the vertical swivel movement in the direction of arrow 34.

Blade 5 is arranged in such a way on the base plate that it can be swiveled downwards and upward around a pivot point 10 in the direction of arrow 33 as a single-arm lever with one-sided attachment.

An opening 11 is formed between knife 6 and blades 4, 5 in rest position, wherein such opening can be so large that a tube-shaped medium with content can pass through the opening without being obstructed by base frame 2 or other components in rest position.

Thus, opening 11, in a first embodiment, can be designed with a broad height ratio of 70:10. Of course, other length, width and height ratios are equally feasible in the embodiment relevant to the invention. Opening 11 at its upper horizontal edge is formed by the horizontal lower edge of blade 5, while the left vertical border is formed by a vertical edge of blade 4 and the right vertical border, by a right vertical attachment at the outer swiveling part of blade 5. The lower edge of opening 11 is formed by the horizontal upper edge of the counter-knife (knife 6).

Accordingly, the size of opening 11 is determined essentially by the horizontal lower edge of blade 5, which is formed in the manner of a swivel blade. Because this blade 5 is pivotable around a large pivot angle of approx. 40 degrees (see FIG. 4), the size of opening 11 is determined by this large pivot angle.

It is essential for this embodiment that blades 4, 5 cannot obstruct opening 11 in rest position, which means that the continuous material can freely pass through the generously sizes opening 11.

This was not feasible in prior art, since a partial cut usually involved at least one blade making an even cut from below or from the top, which meant that the structural height of opening 11 was limited.

Starting from motor 3, the drive force for the two blades 4, 5 is transmitted to a sprocket 12, at which a catch 13 is attached—eccentrically to its rotation axis. In a preferred embodiment, this catch 13 can be shaped as a pin, which engages with the first contour 14 of the first blade 4. The first contour 14 is horizontally situated in the upper area of blade 4 and shaped in such a way that the pin-like catch 13 engages with contour 14, thereby controlling the shifting of blade 4. This is shown in FIGS. 1 to 4 and 9 to 10.

Contour 14 serves as a guiding contour to enable power transmission in the direction of vertical arrow 34, starting from catch 13 or from sprocket 12 to the first blade 4. The first contour 14 is shaped in such a way that it converts the circular movement of sprocket 12 into a linear movement in the direction of arrow 34. Accordingly, blade 4 is designed as a guillotine blade.

According to the invention, catch pin 13 of sprocket 12 simultaneously engages with contour 15 of the second blade 5. The first contour 14 for the vertical, oscillating drive of the first blade 4 is designed as a guiding slot that is approximately inclined skewed to the horizontal plane in the upper part of blade 4.

The second guiding slot, as contour 15, is approximately C-shaped and extends over an angle of rotation of approx. 180 degrees at the circumference of the sprocket, eccentrically to its rotation axis.

Catch 13, which is permanently and eccentrically attached at sprocket 12, therefore engages with the attachment of this blade 5, situated at the pivotable part of blade 5, in which area a half-moon-shaped or C-shaped contour 15 is arranged. Accordingly, blade 5 is swiveled around a pivot point 10 in the direction of arrow 33 as a single-arm lever with one-sided attachment.

That makes it feasible for the first time, starting from the single motor 3 with a single sprocket 12 and a single catch 13, to drive two different blades 4, 5 in an oscillating manner, performing two different cuts simultaneously and synchronously.

The term “simultaneous” in this invention is defined to mean that a single device is able to execute two different cuts, wherein simultaneous may also refer to the time offset resulting from the mutual offset of contours 14, 15 of the two blades 4, 5.

A figure discussed below specifically addresses the special design of contours 14, 15.

In one advantageous embodiment, the lower area of sprocket 12 contains a limit switch 16, which determines the end position of the catch or blade and thereby stops the motor.

Of course, the upper or opposite area may also include a rest position switch, which determines whether the two blades 4, 5 are in open condition, meaning that opening 11 is completely clear. Another advantage of the invention is that knife 6 can be replaced at any time because of mounting points 8 and 9 to install a new or sharpened knife.

FIG. 2 shows the cutter with blade 4 in the lower working position. FIGS. 2a and 2b show the corresponding cross-sections of FIG. 2 along lines D-D and E-E. The invention defines the term “lower working position” as the position reached after cutting through the material. Starting from the top position of catch 13 at sprocket 12, the embodiment according to FIG. 2 involves a rotation in the direction of arrow 17, which enables a linear movement of blade 4 from a rotary movement. Catch 13 turns downwards in the direction of arrow 17 and thereby moves blade 4 downwards in vertical direction 34, which moves the cutting edge of blade 4 along knife 6.

Thus, blade 4 with its cutting edge is specifically moved along a specific area of knife 6, namely area 32, which only generates a small incision (cut 37 in FIG. 10) in the tube-shaped material to allow for subsequent tearing of, e.g. a bag.

It is essential in embodiment according to FIG. 2, 2a, 2b that only blade 4 was moved downwards, wherein blade 5 still remains in its rest position.

The invention defines the term “rest position” to mean that blade 5 remains in the upper area, keeping opening 11 completely clear.

In summary it is to be noted that FIG. 2 only shows a movement for blade 4, while blade 5 remains in its rest position. The position of blade 4 is reached by a rotation of the sprocket together with catch 13 in the direction of arrow 17.

FIG. 3 shows the rotation of sprocket 12 in the direction of arrow 18. Starting from the rest position of the two blades 4, 5, catch 13, which is situated on sprocket 12, is turned to the right in the direction of arrow 18, thereby converting its rotary movement to contour 14 of blade 4 and to contour 15 of blade 5. Due to the different shapes of contours 14, 15, the two blades 4, 5 are either moved simultaneously or in sequence, wherein the tube-shaped material is cut with the exception of a cut-free area and an incision is made in the material at the same time.

It is important that the rotary movement of sprocket 12 and catch 13 drive both a blade 5 designed as a swivel blade around pivot point 10 and a guillotine-like blade 4, which enables a cutting motion in vertical direction.

Starting from the rest position, blade 4 is now moved vertically downwardss to a working position or end position. It is essential for this travel path that blade 4 features a guide spacer 19 in the lower area, which is guided along mounting point 9, thus enabling a guided movement on base frame 2 or within the cutter housing. Mounting point 9 prevents a lateral evasion of blade 4, particularly in the area of guide spacer 19. It is essential for the embodiment according to FIG. 3 that both blade 5 and blade 4 were moved downwards by a rotary movement of sprocket 12 in the direction of arrow 18 and that both an incision (cut 37 in FIG. 10) and a partial cut (cut 36 in FIG. 10) were executed. The invention defines a partial cut as cutting off the continuous material with the exception of a small bridge area (bridge 38 in FIG. 10), wherein this bridge is configured to be so small that a user can later separate the two parts without major effort to receive a single part of the continuous material. The bridge area 38 may, for example, have a size of 1 to 5 mm.

Bridge area 38 makes it possible to separate a section of the continuous material, wherein the section remains attached to the continuous material until it is ultimately “torn off.”

If the cutter is to be used for a cutting process, wherein both an incision is made in the lateral area and a partial cut in the entire area, a package only remains connected to the remaining continuous material (material web 35 in FIG. 10) via the bridge area 38. It is important that blades 4, 5 remain in the lower working position after the cut, which has the advantage that opening 11 is closed and no further continuous material can pass through the opening.

In another advantageous embodiment, both blades 4, 5 can be returned to their rest position, which releases opening 11.

There are a number of different embodiments, wherein a first embodiment always provides a package—completely separated with the exception of bridge area 38—which the user only has to tear off the cutter or off the continuous material.

In another embodiment, a user can interact with the device, for example by pushing a button, which triggers the cutting action of the two blades 4, 5 and provides the user with a package that is separated with the exception of bridge area 38.

Of course, the invention is not limited to separating a package, as it allows for separating any continuous materials such as paper, labels and the like.

FIG. 4 shows blade 5. Blade 5 is configured in such a way that it features a drilling or opening on the left to accommodate a pivot point 10. This means blade 5 is designed as a swivel blade, which performs a rotary motion around the pivot point 10. The right-hand side of blade 5 includes a spacer 22 extending vertically downwards, which is designed as a guiding spacer. Guiding spacer 22 is designed in such a way that it extends vertically downwards in a narrow area, with sufficient distance from the remainder of blade 5 to ensure that blade 5 rests on knife 6. The small bridge-like guiding spacer 22 therefore clears the entire opening 11, since blade 5 only rests on knife 6 in the area of spacer 22 and therefore clears opening 11.

It is essential for blade 5 that a horizontally extending cutting edge be formed in the lower area, which interacts with knife 6.

FIG. 5 shows contour 15 of blade 5. Catch 13 is shown in its rest position, which is located in the upper range of area 23. If the catch is turned to the left in the direction of arrow 17 according to FIG. 3, it would be situated within the one-way clutch of contour 15. If the catch turns to the right in the direction of arrow 18 in accordance with FIG. 3, catch 13 moves in the contour 15 of area 23 and causes blade 5 to move.

This movement is shown in FIG. 6. FIG. 6 shows a rotary movement in the direction of arrow 25 downwards, wherein catch 13 runs along area 23 from its rest position and reaches working position 24. This work position is the end position, wherein in the end position, an incision or partial cut of the tube-shaped continuous material has already occurred.

FIG. 6 also illustrates that a further rotary movement in the direction of the arrow 26 returns catch 13 to its rest position, which causes the transmission of power onto contour 15 and moves blade 5 back to its starting position. The starting position is defined herein as the rest position, in which opening 11 is freely accessible.

If, as shown in FIG. 6, catch 13 is moved against the direction of arrow 26, it moves into the one-way clutch 27 in the direction of arrow 26 and no force is transmitted to blade 5.

It is essential that the movement occurs against the direction of arrow 26, meaning that catch 13 is moved starting from the rest position to one-way clutch area 27, which ensures that no power is transmitted to blade 5. As a further essential characteristic of one-way clutch area 27, it features a trailing area 30, which serves as a tolerance range for the motor control. It is essential that the continuous material be cut in working position 24 or the end position of both blades 4, 5 in such a way that only a cut-free zone 29 remains, meaning that the complete separation of the two materials requires tearing.

FIG. 7 shows the working position of blade 5.

FIG. 8 shows blade 4, wherein blade 4 comprises a contour 14 in the upper area. Contour 14 is shaped as an almost horizontal recess. Catch 13 engages within the recess of sprocket 12 and thereby causes the transmission of power to blade 4. In particular, the special design of contour 14 enables the conversion of a rotary movement to a vertical linear movement of blade 4.

Blade 4 features a spacer 19 in the lower area, which ensures that blade 4 moves along a mounting point at base plate 2, such as for example 9, thereby enabling lateral stabilization within base plate 2 or within the cutter housing 1.

As another characteristic of the invention, blade 4 features a cutting edge 20, which is skewed to the horizontal plane and interacts with the cutting edge of knife 6. Cutting edge 20, in a first advantageous embodiment, is designed as a bevel, enabling a clean cut against knife 6, particularly against cutting area 32. It is important in this regard that cutting area 32 be offset from cutting area 31 on the knife to allow for a clean cut or a simultaneous cut of the two blades 4, 5.

FIG. 9 shows another embodiment of the cutter, wherein both blade 4 and 5 feature a special contour 28 to allow for the distinct control of the two blades 4, 5.

Thus, blade 4 features a contour 28, which enables a transmission of power in a first rotary movement to blade 4, while a rotary movement in the opposite direction causes the release of the knife.

Contour 28 in its upper range features an almost horizontal recess, which engages with catch 13 and thereby causes the transmission of power from sprocket 12 to blade 4. If the sprocket or catch are carry out a rotary movement in the direction of arrow 25, blade 4 executes a linear movement of the vertical direction of arrow 34. Starting from the rest position, a rotary movement can now occur in the direction of arrow 26, wherein the catch moves into one-way clutch area 27 moves and blade 4 remains in its rest position.

As shown in the embodiment of FIGS. 8 and 9, a rotary movement occurs in the direction 25 and blade 4 is swiveled downwards in vertical direction. The other blade 5 remains in its rest position.

If a rotary movement occurs in the direction of arrow 26, blade 4 remains in its rest position due to one-way clutch area 27, while blade 5 is swiveled downwards due to the special shape of contour 15. This now allows for the first time to control two different blades 4, 5 with a single motor in order to execute two different cuts in a continuous material.

Compared to prior art, this also makes it possible for the first time to make highly asymmetric partial cuts, since prior art only allowed a partial cut with a bridge in the center.

The invention has the advantage that an incision can be made, for example in the reinforced lateral area, while the bridge area of the cut-free zone can also be situated eccentrically.

FIG. 10 shows a top view of a material web 35, featuring a cut 36 made laterally by blade 5, which extends from one side beyond the center of material web 35.

Blade 4 executes a short cut 37 (in the length of material web 35) at the opposite side of material web 35, which is offset from cut 36 made by blade 5. Because of the offset between the two cuts 36, 37, the material web 35 is not completely severed, although the sum of both cut lengths of cut 36, 37 matches the width of the material web. This offset between the two cuts 36, 37 forms a non-separated bridge between the inner end of cut 36 and the inner end of cut 37. The complete tearing of material web 35 requires little effort because the opposing ends of the two cuts 36, 37 are skewed, which results in large shearing force on bridge 38.

In summary, the invention makes it possible to control two different blades 4, 5 with a single motor, wherein an incision can be made in the lateral area with a first blade 4, while a second blade 5 executes a partial cut in such a way that a cut-free zone remains to the remaining cut-off. This allows the user for the first time to tear off a package from a continuous material without any effort.

### DRAWING LEGEND

1 Cutter

2 Base plate

3 Motor

4 Blade

5 Blade

6 Knife

7 Step

8 Mounting point

9 Mounting point

10 Pivot point

11 Opening

12 Sprocket

13 Catch

14 Contour

15 Contour

16 Limit switch

17 Arrow

18 Arrow

19 Guiding spacer

20 Cutting edge

21 Cutting edge

22 Guiding spacer

23 Area

24 Working position

25 Arrow

26 Arrow

27 One-way clutch

28 Contour

29 Cut-free zone

30 Trailing area

31 Cutting area

32 Cutting area

33 Arrow

34 Arrow

35 Material web

36 Cut (by 5)

37 Cut (by 4)

38 Bridge

1. Cutter for strip or tape-shaped materials of all kinds, having an electromotive drive for at least one blade (4, 5) which drives the at least one blade (4, 5) in a displaceable manner against a stationary knife (6), characterized in that the electromotive drive (motor 3) has parallel effect on the movement drive of at least two separately movable blades (4, 5), each which execute a cutting motion against the stationary knife (6).

2. Cutter according to claim 1, wherein the electromotive drive is designed as a motor (3), which drives a sprocket (12), on which a catch (13) is arranged eccentrically to the rotation axis, wherein said catch engages simultaneously with the sliding guides (14, 15) of the two blades (4, 5) and drives these together in a displaceable and/or pivoting manner.

3. Cutter according to claim 2, wherein the motor (3) comprises a pinion gear on its drive shaft, which engages with the gearing of the sprocket (12) and drives its rotation.

4. Cutter according to claim 1, wherein that one blade (4) is designed as a vertically moveable guillotine blade and that the other blade (5) is designed as a swivel blade.

5. Cutter according to claim 1, wherein that the sliding gate of blade (4), designed as a guillotine knife, forms a contour (14) running skewed to the horizontal plane for the movable meshing of catch (13).

6. Cutter according to claim 1, wherein the sliding gate of blade (5), designed as a swivel knife, forms an approximately C-shaped contour (15) for the movable meshing of catch (13).

7. Cutter according to claim 1, wherein that a generously proportioned opening (11) for the goods to be cut is designed in such a manner that the upper horizontal edge of opening (11) is formed by the lower horizontal edge of the pivotable blade (5) and that the lower horizontal edge of opening (11) is formed by the upper horizontal edge of the stationary knife (6).

8. Cutter according to claim 1, wherein that the pivotable blade (5) executes a cut ranging from the lateral edge of the material web (35) to the center of the material web (35) and that the vertically movable blade (4) executes a second cut (37) originating from the opposite lateral edge of the material web (35), which ends shortly before the first cut (36).

8. Cutter according to claim 8, wherein the two cuts (36, 37) in the material web (35) are offset skewed, thus forming a tearable bridge (38) between them.

10. Material web for use with a cutter according claim 1, wherein the material web (35) is cut with a longer first cut (36) and an opposite second cut offset skewed to the first cut (36), wherein an uncut bridge (38) remains between the two cuts in the material web (35).
